(19) United States
(12) Patent Application Publication
(10) Pub. No.: US 2007/0240077 A1
(43) Pub. Date: Oct. 11, 2007

(54) Mobile communication terminal and method therefor

(76) Inventors: Kevin McCarthy, Lyngby (DK); Ian Rattigan, Malmo (SE); Christian Kraft, Frederiksberg C (DK); Peter Ib, Herlve (DK); Romel Amineh, Copenhagen (DK); Per Jessen, Copenhagen (DK)

Correspondence Address: PERMAN & GREEN, 425 POST ROAD, FAIRFIELD, CT, 06824, US

(21) Appl. No.: 11/400,732

(22) Filed: Apr. 7, 2006

(51) Int. Cl. G06F 17/00

(52) U.S. Cl. 715/802

(57) ABSTRACT

A method and system for providing a user interface of a mobile communication terminal. The method includes displaying, on an active display, a first view having an application zone and a control zone, the control zone having a plurality of control items, one control item of the plurality of control items being in focus, and the application zone being a display area for a first application, as a response to a first input, shifting focus along a first direction from a focused control item being in focus prior to the first input being effected, to a control item being displayed along the first direction from the focused control item, and as a response to a second input, running software code associated with a control item being in focus when the second input is effected. A corresponding mobile communication terminal and computer program product are also presented.

### FIELD

The disclosed embodiments generally relate to mobile terminals and more particularly to user interfaces in mobile terminals.

### BACKGROUND

Mobile terminals, or mobile (cellular) telephones, for mobile telecommunications systems like GSM, UMTS, D-AMPS and CDMA2000 have been used for many years now. In the older days, mobile terminals were used almost exclusively for voice communication with other mobile terminals or stationary telephones. More recently, the use of modern terminals has been broadened to include not just voice communication, but also various other services and applications such as www/wap browsing, video telephony, electronic messaging (e.g. SMS, MMS, email, instant messaging), digital image or video recording, FM radio, music playback, electronic games, calendar/organizer/time planner, word processing, etc.

A problem with the modern mobile terminals is to be able to provide a simple, yet flexible, user interface, allowing the user to interact with all the different applications in a consistent and simple manner.

One attempt to solve this is to provide a menu system, where the user can select what action to perform in a one-dimensional or two-dimensional menu. However, in the prior art, these menu systems are handled by a menu module, taking control of a bulk part of the screen. Consequently, no screen space is available for a concurrently running application, such as a media player.

Another attempt to solve the problem is to use a small pop-up menu. This may, for example, pop up in a corner when the user presses a key to show the menu. While the use of such a user interface may be useful in some instances, it is sometimes too complicated and cluttered to use.

Consequently, there is a need to provide a simple yet flexible user interface for mobile terminals.

### SUMMARY

In view of the above, an objective of the invention is to solve or at least reduce the problems discussed above.

According to a first aspect of the invention there has been provided a method for providing a user interface of a mobile communication terminal comprising an active display, said method comprising the steps of: displaying, on said active display, a first view comprising an application zone and a control zone, said control zone comprising a plurality of control items, one control item of said plurality of control items being in focus, and said application zone being a display area for a first application, as a response to a first input, shifting focus along a first direction from a focused control item being in focus prior to said first input being effected, to a control item being displayed along said first direction from said focused control item, and as a response to a second input, running software code associated with a control item being in focus when said second input is effected. The user interface thus formed is flexible yet simple, allowing an arbitrary number of actions to be added to the control zone, while still being able to be operated with a limited number of user inputs. Additionally, the user interface can be used with relatively small screens, such as an external display of a mobile communication terminal with two displays, or a small main display, enabling reduced production costs and/or smaller mobile communication terminals.

The method may comprise the further step of: as a response to a third input, shifting focus along a second direction, said second direction differing from said first direction, from a control item being in focus prior to said third input being effected, to a control item being displayed along said second direction from said control item being in focus prior to said third input being effected. The user interface is further enhanced with allowing the user to change focus in two directions.

The first direction may be to the right and said second direction may be to the left.

The first input may be an actuation of a first key, said second input may be an actuation of a second key and said third input may be an actuation of a third key. In other words, three keys may be used to fully operate the described user interface.

The step of displaying an application zone and a control zone may involve rendering said application zone in a first rectangular area and rendering said control zone in a second rectangular area adjacent to said first rectangular area. The disjunct zones makes for an attractive and usable user interface.

The active display may be divided into at least an upper section and a lower section, said first rectangular area being displayed in said upper section and said second rectangular area being displayed in said lower section.

The control items may be displayed as a row of menu icons in said second rectangular area.

The row of menu icons may be centered around a focused control item.

The method comprising an additional step of: displaying a status area in an area of said active display.

The method may comprise the further step of: displaying a key label area in an area of said active display.

The method may comprise the further step of: when a threshold time has passed after a control item focus shift without user input, focus is shifted to a default control item. This further enhances the user experience, with returning focus to the most common control item after a period of no user input.

The control zone may be associated with the first application.

The control zone may be associated with a second application, said second application being distinct from said first application.

The method may comprise the further step of: as a response to an input to rotate view, displaying a second view on said active display, said view comprising said application zone and said control zone, said second view being rotated ninety degrees from said first view, wherein said application zone and said control zone of said second view have a spatial relationship corresponding to a spatial relationship of said first view. This allows for an efficient use of space, where a horizontal menu in a landscape view can fit additional control items compared to a portrait view.

The method may comprise the further step of generating the second input by detecting an absence of user input during a time longer than a threshold time.

A second aspect of the present invention is a method for providing a user interface of a mobile communication terminal comprising an active display, said method comprising the steps of: displaying, in a display area of said active display, a first representation of a first application, said first representation being of a size allowing only one representation at a time to fit completely in said display, as a response to a first input, gradually moving, in a first direction, said representation out from said display area and a second representation of a second application into said display area, such that an edge of said first representation is rendered adjacent to an edge of said second representation during said movement, as a response to a second input, running software code associated with a representation being displayed in said display area when said second input is effected. This user interface is intuitive yet simple, providing an efficient and attractive way for the user to select an action.

A third aspect of the invention is a mobile communication terminal comprising: a display capable of becoming active, and a controller, wherein the controller is configured to display, on said display capable of becoming active, a first view comprising an application zone and a control zone, said control zone comprising a plurality of control items, one control item of said plurality of control items being in focus, and said application zone being a display area for a first application, the controller is further configured to, as a response to a first input, shift focus along a first direction from a focused control item being in focus prior to said first input being effected, to a control item being displayed along said first direction from said focused control item, and the controller is further configured to, as a response to a second input, run software code associated with a control item being in focus when said second input is effected.

The mobile communication terminal may comprise a primary display and an alternative display, said display capable of becoming active being said alternative display.

The mobile communication terminal may be of clamshell type and said alternative display may be an external display of said mobile communication terminal. This allow this simple user interface to be applied to the external display, while the main display may still be operated with a more complex user interface.

A fourth aspect of the present invention is a computer program product comprising software instructions that, when executed in a mobile communication terminal, performs the method according to claim 1.

Other objectives, features and advantages of the present invention will appear from the following detailed disclosure, as well as from the drawings.

Generally, all terms used in the claims are to be interpreted according to their ordinary meaning in the technical field, unless explicitly defined otherwise herein. All references to “a/an/the [element, device, component, means, step, etc]” are to be interpreted openly as referring to at least one instance of the element, device, component, means, step, etc., unless explicitly stated otherwise. The steps of any method disclosed herein do not have to be performed in the exact order disclosed, unless explicitly stated.

### BRIEF DESCRIPTION OF THE DRAWINGS

Embodiments of the invention will now be described in more detail, reference being made to the enclosed drawings, in which:

FIG. 1 is a schematic illustration of a cellular telecommunication system, as an example of an environment in which the invention may be applied.

FIGS. 2a and 2b are two schematic perspective views illustrating a mobile terminal according to an embodiment of the invention.

FIG. 3 is a schematic block diagram representing an internal component, software and protocol structure of the mobile terminal shown in FIG. 2.

FIGS. 4a to 4e are schematic screen illustrations showing part of a user interface according to an embodiment of the invention.

FIGS. 5a to 5c are schematic screen illustrations showing part of a user interface according to an embodiment of the invention.

### DETAILED DESCRIPTION OF THE INVENTION

The aspects of the invention now will be described more fully hereinafter with reference to the accompanying drawings, in which certain embodiments of the invention are shown. This invention may, however, be embodied in many different forms and should not be construed as limited to the embodiments set forth herein; rather, these embodiments are provided by way of example so that this disclosure will be thorough and complete, and will fully convey the scope of the invention to those skilled in the art. Like numbers refer to like elements throughout.

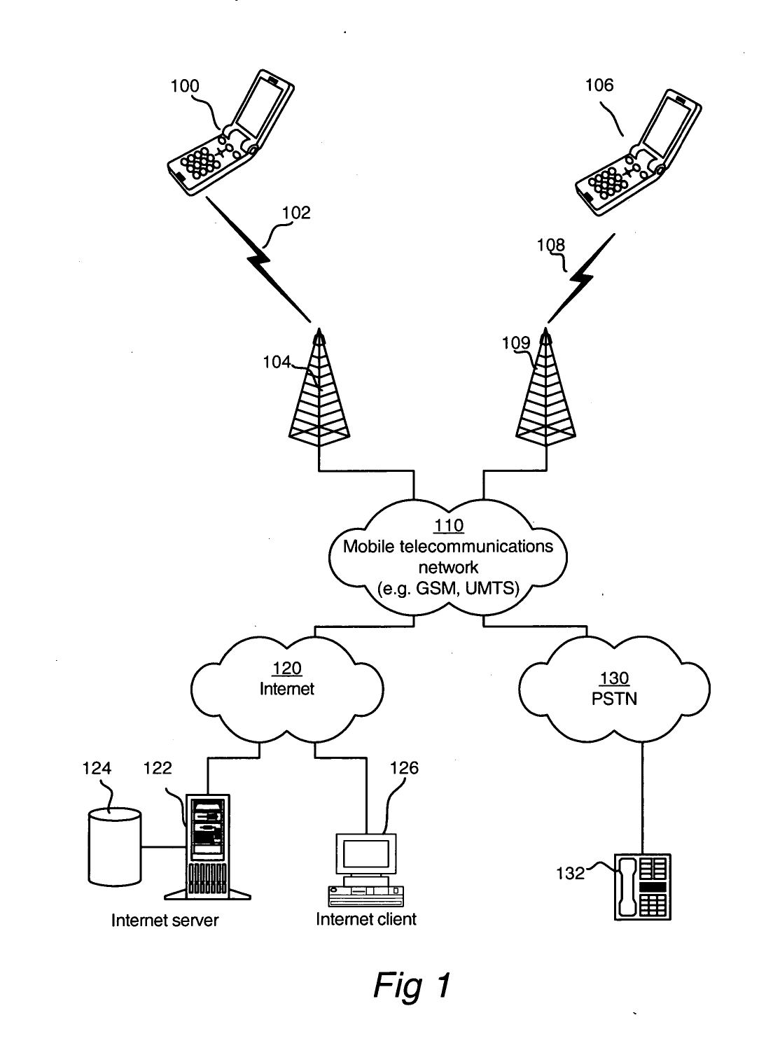

FIG. 1 illustrates an example of a cellular telecommunications system in which the invention may be applied. In the telecommunication system of FIG. 1, various telecommunications services such as cellular voice calls, www/wap browsing, cellular video calls, data calls, facsimile transmissions, music transmissions, still image transmissions, video transmissions, electronic message transmissions and electronic commerce may be performed between a mobile terminal 100 according to the present invention and other devices, such as another mobile terminal 106 or a stationary telephone 132. It is to be noted that for different embodiments of the mobile terminal 100 and in different situations, different ones of the telecommunications services referred to above may or may not be available.

The mobile terminals 100, 106 are connected to a mobile telecommunications network 110 through RF links 102, 108 via base stations 104, 109. The mobile telecommunications network 110 may be in compliance with any commercially available mobile telecommunications standard and/or protocol suite, such as GSM, UMTS, D-AMPS, CDMA2000, FOMA and TD-SCDMA.

The mobile telecommunications network 110 is operatively connected to a wide area network 120, which may be Internet or a part thereof. An Internet server 122 has a data storage 124 and is connected to the wide area network 120, as is an Internet client computer 126. The server 122 may host a www/wap server capable of serving www/wap content to the mobile terminal 100.

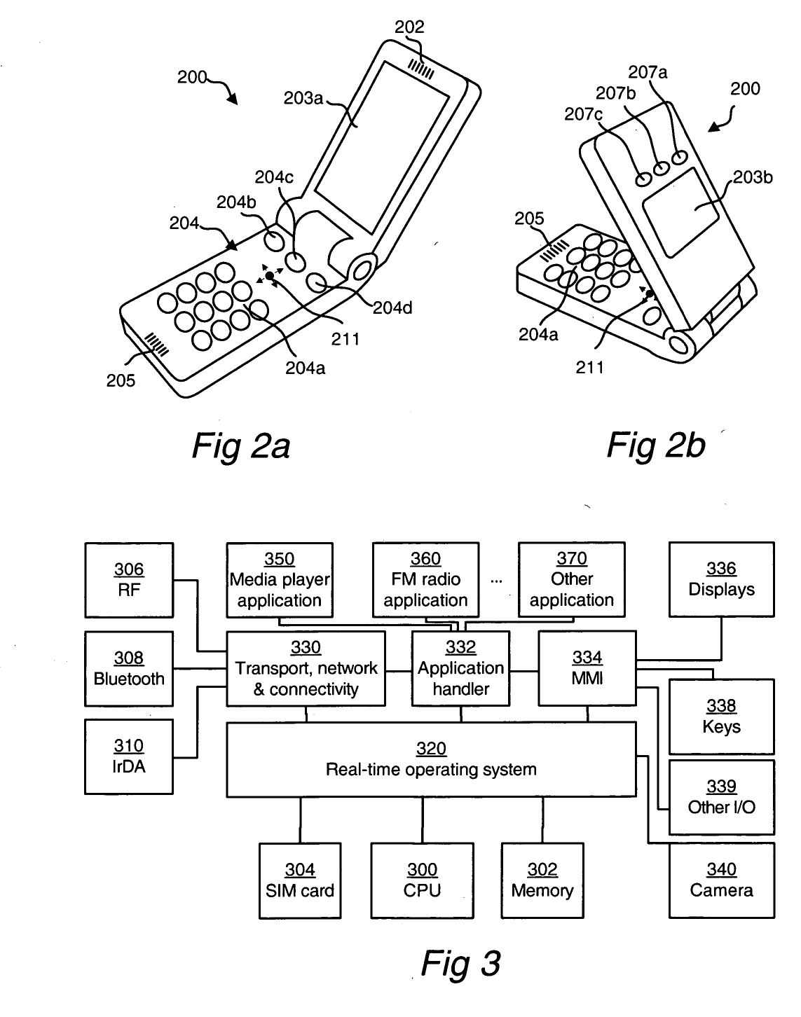

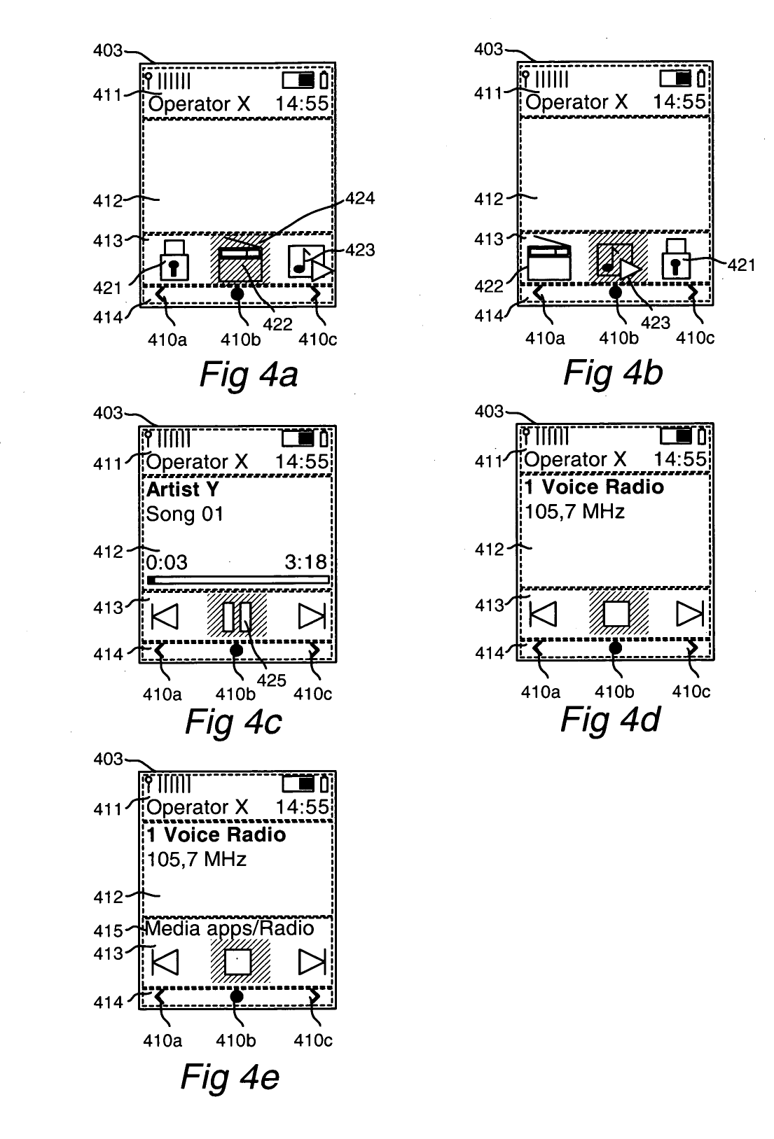

An embodiment 200 of the mobile terminal 100 is illustrated in more detail in FIGS. 2a and 2b. In this embodiment, the mobile terminal is of a type known in the industry as a clam-shell mobile terminal. This type of mobile terminal is foldable and comprises two displays: one main internal display 203a and one alternative external display 203b, where the alternative external display 203b is smaller than the main internal display 203a. Due to the smaller size of the external display 203b, there is a problem to be able to show information from an application while also providing the user with an interactive user interface. A solution to this problem will be described in a user interface in conjunction with FIG. 4 below. The mobile terminal 200 further comprises a speaker or earphone 202, a microphone 205 and a set of internal keys 204 which may include a keypad 204a of common ITU-T type (alpha-numerical keypad representing characters “0”-“9”, “*” and “#”) and certain other keys such as soft keys 204b, 204c, 204d and a joystick 211 or other type of navigational input device. Moreover, there is provided an external set of keys 207, in this embodiment comprising three keys 207a, 207b and 207c, externally on the mobile terminal.

The internal component, software and protocol structure of the mobile terminal 200 will now be described with reference to FIG. 3. The mobile terminal has a controller 300 which is responsible for the overall operation of the mobile terminal and may be implemented by any commercially available CPU (“Central Processing Unit”), DSP (“Digital Signal Processor”) or any other electronic programmable logic device. The controller 300 has associated electronic memory 302 such as RAM memory, ROM memory, EEPROM memory, flash memory, or any combination thereof. The memory 302 is used for various purposes by the controller 300, one of them being for storing data and program instructions for various. software in the mobile terminal. The software includes a real-time operating system 320, drivers for a man-machine interface (MMI) 334, an application handler 332 as well as various applications. The applications include a media player application 350, an FM radio application 360, as well as various other applications 370, such as applications for voice calling, video calling, sending and receiving SMS, MMS or email, an instant messaging application, a phone book application, a calendar application, a word processing application, a presentation application, a spreadsheet application, a control panel application, a camera application, one or more video games, etc.

The MMI 334 also includes one or more hardware controllers, which together with the MMI drivers cooperate with the displays 336 (internal and external where applicable), keys 338 (internal and external where applicable) as well as various other I/O devices 339 such as microphone, speaker, vibrator, ringtone generator, LED indicator, etc. As is commonly known, the user may operate the mobile terminal through the man-machine interface thus formed.

The software also includes various modules, protocol stacks, drivers, etc., which are commonly designated as 330 and which provide communication services (such as transport, network and connectivity) for an RF interface 306, and optionally a Bluetooth interface 308 and/or an IrDA interface 310. The RF interface 306 comprises an internal or external antenna as well as appropriate radio circuitry for establishing and maintaining a wireless link to a base station (e.g. the link 102 and base station 104 in FIG. 1). As is well known to a person skilled in the art, the radio circuitry comprises a series of analogue and digital electronic components, together forming a radio receiver and transmitter. These components include, i.a., band pass filters, amplifiers, mixers, local oscillators, low pass filters, AD/DA converters, etc.

The mobile terminal also has a SIM card 304 and an associated reader. As is commonly known, the SIM card 304 comprises a processor as well as local work and data memory.

Hereinbelow follows a description of a few user interface scenarios according to embodiments of the present invention.

FIGS. 4a to 4e are schematic screen illustrations showing part of a user interface according to an embodiment of the present invention. A screen 403, such as the external display 203b of FIG. 2b, is used to render output of a user interface of an embodiment of the present invention. The display can comprise four zones: a status zone 411, an application zone 412, a control zone 413 and a key label zone 414. Any of these zones may be included or omitted as deemed suitable, e.g. with regard to available display space and desired functionality. The status zone 411 contains operational information of the mobile terminal, such as current signal strength, battery level, operator, current time, etc.

The application zone 412 is a zone where a currently running application can display any suitable information. For example, in FIG. 4c, a media player application is currently executing in the mobile terminal. Here the application zone 412 is used by the media player application to display the name of the artist of the currently playing song (Artist Y), the name of the currently playing song (Song 01), a current time position in the currently playing song (0:03), a length of the currently playing song (3:18) and a visual representation of the current position in the currently playing song. Note that the idle screen is also considered an application, as the idle screen also has software code adapted to present data, and can as such control the appearance of the application zone 412.

The key label zone 414 comprises three labels, a left indicator 410a, an activate indicator 410b and a right indicator 410c. The three labels 410a-c are respectively associated with three keys, such as keys 207a-c of FIG. 2b.

The control zone 413 comprises a number of icons, or representations, allowing the user to choose an action to be performed by the mobile terminal. These icons may be, but are not necessarily, associated with the application that is currently associated with the application zone 412. For example, the application zone 412 may belong to a media player application currently playing music, while the control zone 413 is used to control call handling, synchronization, flight mode, etc. In FIG. 4a, there are three icons displayed in the control zone 413: a key lock icon 421, an FM radio icon 422 and a media player icon 423. The middle icon, in this case the FM radio icon 422, is highlighted. In this example, the highlighting is performed with shading 424, but any other suitable method of highlighting can be used, such as inverting, a relative increase in size, enhancing contrast, color enhancement, etc.

In one embodiment, the control zone 413 is hidden while not used and is only shown when the user presses one of the keys associated with the indicators 410a-c.

If the user presses the key associated with the right indicator 410c, the icons 421, 422, 423 in the control zone 413 are scrolled to a view as can be seen in FIG. 4b. Consequently, the media player icon, which was previously in the right position of the control zone 413, is now in the middle position and is thus highlighted. The icons wrap around, so that the right position now contains the key lock icon 421. If there are more icons than can be displayed in the control zone 413 simultaneously, the order of the icons is still preserved, while only displaying the number of icons that can fit in the control zone 413, in this example three icons. The FM radio icon 421 has shifted to the left position in the control zone. The left indicator 410a works in a corresponding manner, only in the opposite direction to the right indicator 410c.

If the user then presses the key associated with the activate indicator 410b, software code associated with the currently highlighted icon is executed. In the case of FIG. 4b, where the media player icon is highlighted, software code is executed to launch the media player application, resulting in a view such as the view shown in FIG. 4c. In one embodiment, if the user does not press any of the keys associated with the indicators 410a-c, focus is returned to a default control icon after a specific amount of time. For example, in the media player showing in FIG. 4c, focus is returned to a pause icon 424 after a period of inactivity, regardless of what icon is in focus previously. In another embodiment, if the user does not press any of the keys associated with the indicators 410a or 410c, it is determined by the controller that software code associated with the currently highlighted icon is to be executed. In other words, in this embodiment, a timeout activates the currently highlighted icon.

A user interface is thus formed where the user can navigate through a list of potential choices using the keys associated with the left indicator 410a and the right indicator 410c. Once the user has placed an icon corresponding to a desired action in the highlighted area 424, the action is simply activated by pressing the key associated with the activate indicator 410b. This user interface is simple, yet flexible enough to allow an arbitrary number of actions. Moreover, the control zone 413 only occupies part of the screen 403, providing space for an application zone 412.

FIG. 4d shows an example of a view where an FM radio application is running.

FIG. 4e shows an example where the described user interface has been used to navigate through a menu hierarchy. An icon shown in the control zone 413 may either be an intermediate node with additional items below it, or a leaf with an action associated with it. For example, a menu may have a top level consisting of items such as media applications, games, phone settings, phone directory, etc. Of these, media applications and games are intermediate nodes, while phone settings and phone directory are leafs, where applications are started immediately upon activation. If the user for example navigates to media, there are a number of sub-items shown in the control zone 413, such as media player, FM radio, camera, etc. The user may then activate the FM radio, resulting in a view such as the view shown in FIG. 4e. The view is similar to the FM radio view mentioned above in FIG. 4d, but the hierarchy above and including the current node is shown in the control zone 413 as a hierarchy representation 415. The hierarchy representation 415 here is shown as text information, but a graphical representation of the hierarchy is equally possible.

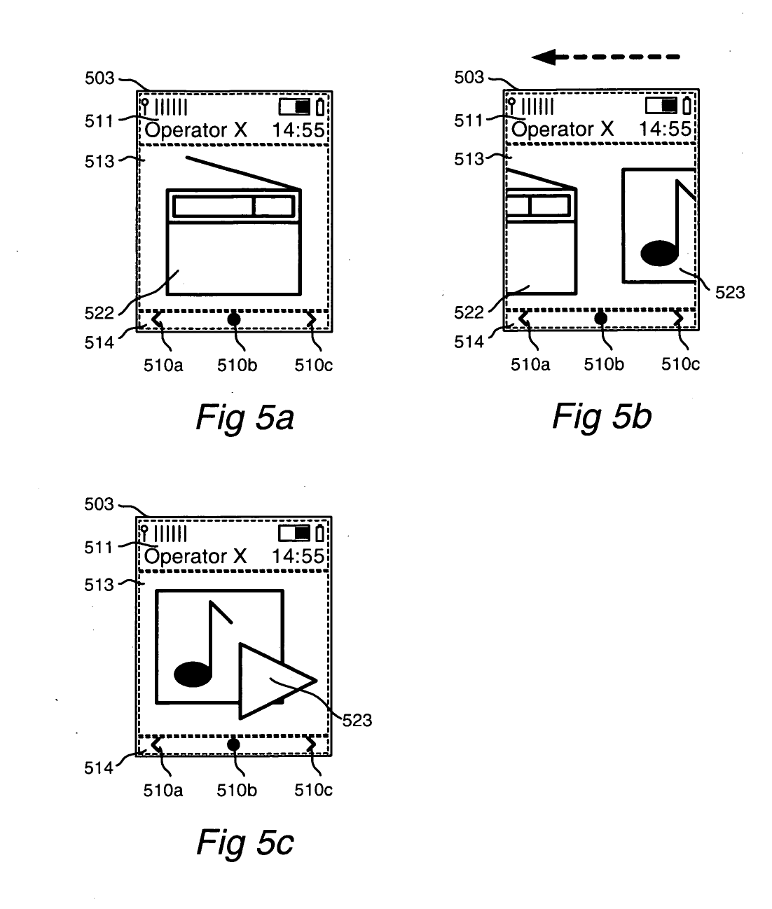

FIGS. 5a to 5c are schematic screen illustrations of a user interface according to one embodiment of the present invention. The user interface is similar to the user interface described above, but without the application zone and with only one representation being able to fully fit on the screen.

A screen 503, such as the external display 203b of FIG. 2b, is used to render output of a user interface of this embodiment of the present invention. The display can comprise three zones, a status zone 511, a control zone 513 and a key label zone 514. Any of these zones may be included or omitted as deemed suitable, e.g. with regard to available display space and desired functionality. As with the status zone 411 of FIGS. 4a-e, the status zone 511 contains operational information of the mobile terminal, such as current signal strength, battery level, operator, current time, etc.

As with the key label zone of FIGS. 4a-e, the key label zone 514 comprises three labels, a left indicator 510a, an activate indicator 510b and a right indicator 510c. The three labels 510a-c are respectively associated with three keys, such as keys 207a-c of FIG. 2b.

In this embodiment, the control representations are larger compared to the control representations shown in FIGS. 4a-e, being able to occupy the full width and height of the control zone 513. For example, in FIG. 5a, an icon 522 for an FM radio, with its spacing around, occupies the entire control zone 513. If the user then presses the key associated with the right indicator 510c, as is shown in FIG. 5b, a representation 523 logically located to the right of the current representation 522 starts to move into the control zone 513 from the right. Meanwhile, the current representation 522 is moved out to the left. Consequently, the representation 523 for the media player is seamlessly connected to the representation 522 for the FM radio, which is shown in a transitional animation when shifting focus from one representation to another. Once the transition is complete, as is shown in FIG. 5c, the control zone 513 only displays the representation 523 for the media player.

While the representations illustrated here are graphic icons, any suitable graphic representation may be used. For example, applications may have representations being screenshots. The screenshots can be static screenshots stored in memory 302 at a time when software is loaded on the mobile terminal, or the screenshots may be dynamic, being captured (automatically or as a response to a user input) from the presently used mobile terminal at a time when the application in question is used.

While the user interface described above is implemented using the external display, the present invention may be implemented using any display of a mobile communication terminal, such as a main display of a clamshell mobile terminal or an only display of a terminal with only one display.

The invention has mainly been described above with reference to a few embodiments. However, as is readily appreciated by a person skilled in the art, other embodiments than those disclosed above are equally possible within the scope of the invention, as defined by the appended patent claims.

What is claimed is:

1. A method for providing a user interface of a mobile communication terminal comprising an active display, said method comprising:
displaying, on said active display, a first view comprising an application zone and a control zone, said control zone comprising a plurality of control items, one control item of said plurality of control items being in focus, and said application zone being a display area for a first application,
as a response to a first input, shifting focus along a first direction from a focused control item being in focus prior to said first input being effected, to a control item being displayed along said first direction from said focused control item, and
as a response to a second input, running software code associated with a control item being in focus when said second input is effected.

2. The method for providing a user interface according to claim 1, further comprising:
as a response to a third input, shifting focus along a second direction, said second direction differing from said first direction, from a control item being in focus prior to said third input being effected, to a control item being displayed along said second direction from said control item being in focus prior to said third input being effected.

3. The method for providing a user interface according to claim 2, wherein said first direction is to the right and said second direction is to the left.

4. The method for providing a user interface according to claim 2, wherein said first input is an actuation of a first key, said second input is an actuation of a second key and said third input is an actuation of a third key.

5. The method for providing a user interface according to claim 1, wherein displaying an application zone and a control zone involves rendering said application zone in a first rectangular area and rendering said control zone in a second rectangular area adjacent to said first rectangular area.

6. The method for providing a user interface according to claim 5, wherein said active display is divided into at least an upper section and a lower section, said first rectangular area being displayed in said upper section and said second rectangular area being displayed in said lower section.

7. The method for providing a user interface according to claim 5, wherein said control items are displayed as a row of menu icons in said second rectangular area.

8. The method for providing a user interface according to claim 7, wherein said row of menu icons is centered around a focused control item.

9. The method for providing a user interface according to claim 5, said method further comprising displaying a status area in an area of said active display.

10. The method for providing a user interface according to claim 5, further comprising displaying a key label area in an area of said active display.

11. The method for providing a user interface according to claim 2, further comprising
when a threshold time has passed after a control item focus shift without user input, shifting focus to a default control item.

12. The method for providing a user interface according to claim 1, wherein said control zone is associated with said first application.

13. The method for providing a user interface according to claim 1, wherein said control zone is associated with a second application, said second application being distinct from said first application.

14. The method for providing a user interface according to claim 1, further comprising:
as a response to an input to rotate view, displaying a second view on said active display, said view comprising said application zone and said control zone, said second view being rotated ninety degrees from said first view, wherein said application zone and said control zone of said second view have a spatial relationship corresponding to a spatial relationship of said first view.

15. The method for providing a user interface according to claim 1, further comprising generating said second input by detecting an absence of user input during a time longer than a threshold time.

16. A method for providing a user interface of a mobile communication terminal comprising an active display, said method comprising:
displaying, in a display area of said active display, a first representation of a first application, said first representation being of a size allowing only one representation at a time to fit completely in said display area,
as a response to a first input, gradually moving, in a first direction, said representation out from said display area and a second representation of a second application into said display area, such that an edge of said first representation is rendered adjacent to an edge of said second representation during said movement,
as a response to a second input, running software code associated with a representation being displayed in said display area when said second input is effected.

17. A mobile communication terminal comprising:
a display capable of becoming active, and
a controller, wherein said controller is configured to display, on said display capable of becoming active, a first view comprising an application zone and a control zone, said control zone comprising a plurality of control items, one control item of said plurality of control items being in focus, and said application zone being a display area for a first application,
said controller is further configured to, as a response to a first input, shift focus along a first direction from a focused control item being in focus prior to said first input being effected, to a control item being displayed along said first direction from said focused control item, and
said controller is further configured to, as a response to a second input, run software code associated with a control item being in focus when said second input is effected.

18. The mobile communication terminal according to claim 17, wherein said mobile communication terminal comprises a primary display and an alternative display, said display capable of becoming active being said alternative display.

19. The mobile communication terminal according to claim 18, wherein said mobile communication terminal is of clamshell type and said alternative display is an external display of said mobile communication terminal.

20. A computer program product comprising software instructions that, when executed in a mobile communication terminal, performs the method according to claim 1.
